(19) United States
(12) Patent Application Publication
(10) Pub. No.: US 2026/0323439 A1
(43) Pub. Date: Oct. 15, 2026

(54) METHOD AND APPARATUS FOR MOBILITY MANAGEMENT

(71) Applicant: 1FINITY Inc., Kawasaki-shi (JP)

(72) Inventor: Tingting GENG, Beijing (CN)

(73) Assignee: 1FINITY Inc., Kawasaki-shi (JP)

(21) Appl. No.: 19/691,940

(22) Filed: May 29, 2026

Related U.S. Application Data
(63) Continuation of application No. PCT/CN2023/139126, filed on Dec. 15, 2023.

(51) Int. Cl. H04W 36/04; H04W 36/30; H04W 76/19

(52) U.S. Cl. CPC H04W 36/04; H04W 36/305; H04W 76/19

(57) ABSTRACT

An apparatus for mobility management, configured in a first network device, includes: a receiver configured to receive a first report transmitted by a terminal equipment, the first report comprising LTM (layer 1/layer 2 triggered mobility) connection failure information; and processor circuitry configured to determine a type of an LTM connection failure according to the first report, the type of the LTM connection failure comprising one of the following: too late LTM, too early LTM, or LTM to wrong cell.

### CROSS-REFERENCE TO RELATED APPLICATION

This application is a continuation application under 35 U.S.C. 111(a) of International Patent Application PCT/CN2023/139126 filed on Dec. 15, 2023, and designated the U.S., the entire contents of which are incorporated herein by reference.

### TECHNICAL FIELD

Embodiments of the present disclosure relate to the technical field of communications.

### BACKGROUND

Mobility scenarios in radio communication systems include lower layer triggered mobility (L1/L2 triggered mobility (LTM)) scenarios. In LTM, a network device transmits configuration information of an LTM candidate cell to a terminal equipment, and the terminal equipment performs downlink and/or uplink synchronization procedures with an LTM candidate cell. The terminal equipment performs L1 measurement and transmits an L1 measurement result corresponding to the LTM candidate cell to the network device. The network device determines an LTM target cell of LTM cell switch for the terminal equipment according to the L1 measurement result, and transmits the LTM target cell of LTM cell switch to the terminal equipment via L2 signaling. Correspondingly, the terminal equipment performs an LTM cell switch procedure to the LTM target cell.

FIG. 1 is a schematic diagram of a possible LTM procedure. As shown in FIG. 1, the procedure may include the following steps:
Step 1: a User Equipment (UE) transmits a measurement report (MeasurementReport) to a base station (gNB);
Step 2: the UE receives configuration information of one or more LTM candidate cells, transmitted by the base station;
Step 3: the UE stores received configuration information of LTM candidate cell(s) and transmits a response message to the base station;
Step 4a: the UE performs downlink synchronization with LTM candidate cell(s);
Step 4b(optional): the UE performs uplink synchronization with corresponding LTM candidate cell(s) according to the configuration information from the base station;
Step 5: the UE performs L1 measurement and transmits an L1 measurement result to the base station;
Step 6: the UE receives a Media Access Control (MAC) Control Element (MAC CE) for indicating a cell switch command, transmitted by the base station, the MAC CE including indication information of an LTM target cell;
In step 6, optionally, the MAC CE may include Timing Advance (TA) information of the LTM target cell;
Step 7 (optional): if the UE does not possess a valid TA corresponding to the LTM target cell, the UE performs a random access procedure with the LTM target cell when performing the LTM cell switch procedure with the LTM target cell; and
Step 8: the UE completes the LTM cell switch procedure with the LTM target cell.

In the above process, if step 7 is performed, when the UE successfully completes the random access procedure with the LTM target cell, it may be considered that the UE has successfully completed the LTM cell switch procedure.

In the above process, if step 7 is not performed, when the UE determines that a network device to which the LTM target cell belongs successfully receives the first uplink data transmitted by the UE, it may be considered that the UE has successfully completed the LTM cell switch procedure. For example, when the UE, in the LTM target cell, receives a Physical Downlink Control Channel (PDCCH) addressed with a UE's Cell Radio-Network Temporary Identifier (C-RNTI), the PDCCH being used to schedule new data transmission, the UE considers that the network device has successfully received the first uplink data transmitted by the UE.

It should be noted that the above introduction to the technical background is just to facilitate a clear and complete description of technical solutions of the present disclosure, and is elaborated to facilitate understanding of persons skilled in the art. It cannot be considered that the technical solutions are known by persons skilled in the art just because these solutions are elaborated in Background of the present disclosure.

### SUMMARY

Inventors find that during LTM, if a connection failure occurs, it is necessary to consider optimizing LTM-related configurations for subsequent mobility management. The connection failure includes failure types such as a radio link failure (RLF), a handover failure (HOF), or a connection failure between a terminal equipment and a current serving cell caused by timer expiry or other reasons.

Currently, self-organization networks (SONs) introduce network optimization-related mechanisms, including a mobility robustness optimization (MRO) mechanism. In existing MRO mechanisms, by recording parameters during a mobility procedure, generating a corresponding mobility report, and reporting to a network device, by a terminal equipment, so that the network device may determine a failure type of a handover failure according to contents of the mobility report, the failure type of the handover failure e.g. including too late handover, too early handover, or handover to a wrong cell.

The mobility report may include at least one of the following reports: a failure report, a successful mobility report, a random access report (RA report), a connection establishment failure report (CEF report), or other reports. The failure report includes any one or more of a radio link failure report (RLF report) or other failure reports, and the successful mobility report includes various successful mobility reports, such as any one or more of a successful handover report, a successful secondary cell addition or switch report, or other successful reports.

In addition, the mobility report may include connection failure time information, the connection failure time information may be used to indicate a time duration from when a terminal equipment last (or most recently) received a handover command (or a reconfiguration message) to when the terminal equipment detects a connection failure.

However, in existing SON mechanisms, there are no LTM-related optimization operations. Therefore, it is necessary to consider defining MRO-related scenarios in LTM mobility scenarios to assist the network device in optimizing corresponding configuration parameters.

For at least one of the above problems or other similar problems, embodiments of the present disclosure provide a method and an apparatus for mobility management.

According to an aspect of embodiments of the present disclosure, a method for mobility management is provided, wherein the method includes that,
a first network device receives a first report transmitted by a terminal equipment, the first report including LTM connection failure information; and
the first network device determines a type of an LTM connection failure according to the first report, the type of the LTM connection failure including one of the following: too late LTM, too early LTM, or LTM to wrong cell.

According to another aspect of embodiments of the present disclosure, an apparatus for mobility management is provided, configured in a first network device, wherein the apparatus includes:
a receiving unit configured to receive a first report transmitted by a terminal equipment, the first report including LTM connection failure information; and
a determining unit configured to determine a type of an LTM connection failure according to the first report, the type of the LTM connection failure including one of the following: too late LTM, too early LTM, or LTM to wrong cell.

In some embodiments, the LTM connection failure information includes at least one of the following:
first information for indicating that a mobility type related to a connection failure is LTM;
second information for indicating a time duration corresponding to the connection failure;
third information for indicating a cell where the connection failure occurs; or
fourth information for indicating a type of the connection failure.

In some embodiments, that the determining unit determines the type of the LTM connection failure according to the first report comprises:
if it is determined according to the first report that the terminal equipment has received configuration information of an LTM candidate cell, and the terminal equipment has detected a connection failure with a cell that transmits the configuration information of the LTM candidate cell, and,
if the second information is not in the first report, or if the time duration indicated by the second information in the first report is greater than or equal to a first time threshold,
the determining unit determines that the type of the LTM connection failure corresponding to the first report is too late LTM.

In some embodiments, that the determining unit determines the type of the LTM connection failure according to the first report comprises:
if it is determined according to the first report that the terminal equipment has detected a connection failure with an LTM target cell, and,
if the time duration indicated by the second information in the first report is less than or equal to a second time threshold, and a cell where the terminal equipment attempts re-establishment for the first time or a cell where the terminal equipment attempts LTM recovery for the first time is a cell where the terminal equipment receives an LTM cell switch message or a cell where the terminal equipment receives an LTM initialization message,
the determining unit determines that the type of the LTM connection failure corresponding to the first report is too early LTM.

In some embodiments, that the determining unit determines the type of the LTM connection failure according to the first report comprises:
if it is determined according to the first report that the terminal equipment has detected a connection failure with an LTM target cell, and,
if the time duration indicated by the second information in the first report is less than or equal to a third time threshold, and a cell where the terminal equipment attempts re-establishment for the first time or a cell where the terminal equipment attempts LTM recovery for the first time is a cell other than a cell where the terminal equipment receives an LTM cell switch message or a cell where the terminal equipment receives an LTM initialization message, or the LTM target cell,
the determining unit determines that the type of the LTM connection failure corresponding to the first report is LTM to wrong cell.

One of advantageous effects of embodiments of the present disclosure lies in that according to embodiments of the present disclosure, a SON enhancement scheme in an LTM scenario is introduced, failure information related to LTM reported by a UE is introduced, and an LTM failure scenario is defined, such that a network device may identify an LTM failure scenario according to a mobility report related to an LTM scenario, thereby to perform corresponding parameter adjustments, and thus LTM robustness is improved.

Referring to later descriptions and drawings, specific implementations of the present disclosure are disclosed in detail, indicating modes in which principles of the present disclosure may be adopted. It should be understood that implementations of the present disclosure are not limited in scope thereby. Within spirits and scopes of terms of attached claims, implementations of the present disclosure include many changes, modifications, and equivalents.

Feature(s) described and/or shown for one implementation may be used in one or more other implementations in the same way or in a similar way, and may be combined with or replace feature(s) in other implementations.

It should be emphasized that term “include/contain” when being used herein refers to presence of a feature, a whole piece, a step, or a component, but does not exclude presence or addition of one or more other features, whole pieces, steps, or components.

### BRIEF DESCRIPTION OF DRAWINGS

Element(s) and feature(s) described in one drawing or one implementation of embodiments of the present disclosure may be combined with element(s) and feature(s) shown in one or more other drawings or implementations. In addition, in the drawings, similar reference signs denote corresponding components in several drawings, and may be used to indicate corresponding components used in more than one implementation.

FIG. 1 is a schematic diagram of an LTM procedure;

FIG. 2 is a schematic diagram of a method for mobility management in embodiments of a first aspect of the present disclosure;

FIG. 3 is a schematic diagram of an information interaction process according to a method in embodiments of the present disclosure;

FIG. 4 is a schematic diagram of a method for mobility management in embodiments of a second aspect of the present disclosure;

FIG. 5 is a schematic diagram of an apparatus for mobility management in embodiments of the present disclosure;

FIG. 6 is another schematic diagram of an apparatus for mobility management in embodiments of the present disclosure;

FIG. 7 is a schematic diagram of a communication system in embodiments of the present disclosure;

FIG. 8 is a schematic diagram of a network device in embodiments of the present disclosure;

FIG. 9 is a schematic diagram of a terminal equipment in embodiments of the present disclosure.

### DETAILED DESCRIPTION

Referring to the drawings, through the following Specification, the aforementioned and other features in the present disclosure will become obvious. Specification and the drawings specifically disclose specific implementations of the present disclosure, indicating partial implementations in which principles of the present disclosure may be adopted. It should be understood that the present disclosure is not limited to described implementations, on the contrary, the present disclosure includes all modifications, variations and equivalents falling within scopes of attached claims.

In embodiments of the present disclosure, terms “first” and “second”, etc. are used to distinguish different elements in terms of appellation, but do not represent a spatial arrangement or time sequence, etc. of these elements, and these elements should not be limited by these terms. Term “and/or” includes any one of and all combinations of one or more of terms listed in an associated manner. Terms “contain”, “include” and “have”, etc. refer to presence of stated feature(s), element(s), component(s), or assembly/assemblies, but do not exclude presence or addition of one or more other features, elements, components, or assemblies.

In embodiments of the present disclosure, singular forms “a/an” and “the”, etc. include plural forms, and should be understood broadly as “a kind of” or “a type of”, but are not defined as the meaning of “one”, in addition, term “the” should be understood to include both singular forms and plural forms, unless a context clearly indicates otherwise. In addition, term “according to” should be understood as “at least partially according to . . . ”, and term “based on” should be understood as “at least partially based on . . . ”, unless a context clearly indicates otherwise.

In embodiments of the present disclosure, scenarios containing a network device and/or a terminal equipment are taken as examples.

In the above scenarios, the network device may include at least one of a core network device, a third-party application device, an operation administration and maintenance (OAM) device, or an access network device.

The core network device may refer to a device in a core network (CN) that provides service support for terminal equipments. As some instances, the core network device may be at least one of the following: a mobility and management entity (MME), an access and mobility management function (AMF) entity, a session management function (SMF) entity, a user plane function (UPF) entity, a Location Management Function (LMF) entity, etc., which are not exhaustively listed here. The AMF entity may be responsible for access management and mobility management of terminals, the SMF entity may be responsible for session management, such as session establishment of a user, and the UPF entity may be a functional entity of a user plane and is primarily responsible for connecting to external networks. The LMF entity may manage overall coordination and scheduling of resources required for positions of terminal equipments registered with or accessing a core network device. It should be noted that in embodiments of the present disclosure, the entity may also be called a network element or a functional entity. For example, the AMF entity may also be called an AMF network element or an AMF functional entity, and so on.

The third-party application device may be an OTT server (over the top server) or other third-party device.

The OAM device may be a network device that performs management work such as operation, administration, and maintenance, etc. on a network according to actual needs of an operator's network operations.

The access network device is an access device through which a terminal equipment wirelessly accesses a communication system. The access network device may be a base station (BS), an evolved NodeB (eNodeB), a transmission reception point (TRP), a base station (next generation NodeB, gNB) in a 5th generation (5G) mobile communication system, a base station in a 6th generation (6G) mobile communication system, a base station in a future mobile communication system or an access node in a WiFi system, etc. The access network device may further be a module or unit that completes part of functions of a base station, for example, may be at least one of the following modules or units: a central unit (CU), a distributed unit (DU), a central unit control plane (CU-CP), a central unit user plane (CU-UP), an Integrated Access Backhaul (IAB), or other module or unit. Embodiments of the present disclosure do not define specific technologies and/or specific device forms adopted by the access network device. The access network device may be deployed on land, including indoors/outdoors, and may be handheld or vehicle-mounted, or may further be deployed on water surfaces, on planes, balloons, or satellites. The access network device may be deployed in a fixed position or on a mobile carrier. Embodiments of the present disclosure do not define in this regard.

In the above scenarios, the terminal equipment may be a device having a wireless transceiving function, may transmit signals to the access network device and/or receive signals from the access network device. The terminal equipment may also be called a terminal, a mobile station, or a mobile terminal, etc. The terminal equipment may be a mobile phone, a tablet, or other device having a wireless smart transceiving function. The terminal equipment may be widely applied in various scenarios, such as device-to-device (D2D), vehicle-to-everything (V2X) communication, machine-type communication (MTC), Internet of Things (IoT), virtual reality, augmented reality, industrial control, autonomous driving, telemedicine, or various smart scenarios.

In the above scenarios, communication between an access network device and a terminal equipment and communication between terminal equipments may be performed via licensed spectrum, or via license-free spectrum, or via both licensed spectrum and license-free spectrum simultaneously. Embodiments of the present disclosure do not define spectrum resources used for wireless communications.

Embodiments of the present disclosure are described below in conjunction with the drawings and specific implementations. For ease of description, the following text takes a base station as an example of an access network device for description. In the following descriptions, without causing confusion, “if . . . ”, “in a case where . . . ” and “when . . . ” may be used interchangeably.

### Embodiments of a First Aspect

Embodiments of the present disclosure provide a method for mobility management, which is described from a first network device side.

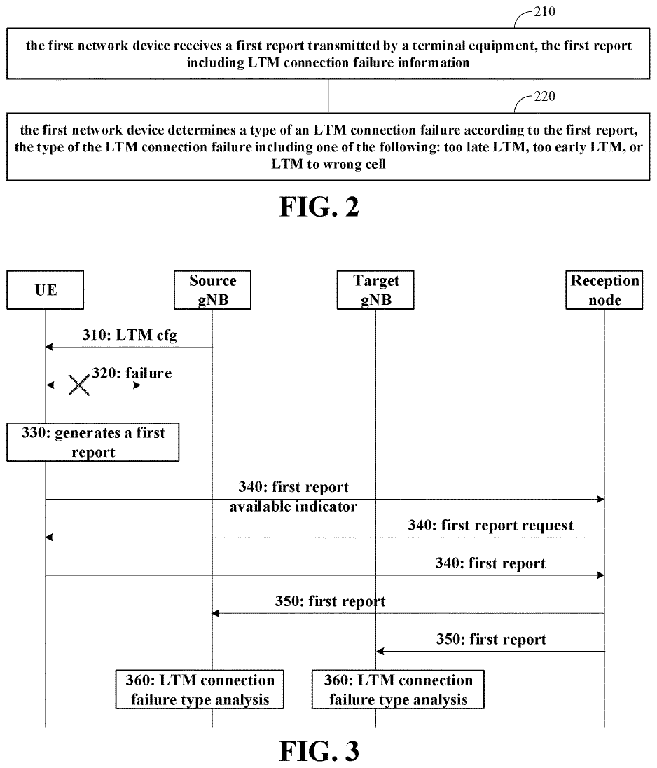

FIG. 2 is a schematic diagram of the method for mobility management in embodiments of the present disclosure, as shown in FIG. 2, the method includes:
210: the first network device receives a first report transmitted by a terminal equipment, the first report including LTM connection failure information; and
220: the first network device determines a type of an LTM connection failure according to the first report, the type of the LTM connection failure including one of the following: too late LTM, too early LTM, or LTM to wrong cell.

It is worth noting that the above FIG. 2 only schematically describes embodiments of the present disclosure, however the present disclosure is not limited thereto. For example, some other operations may be added or certain operations therein may be reduced. Persons skilled in the art may make appropriate modifications according to the above contents, not being limited to records in the above FIG. 2.

In embodiments of the present disclosure, the first report is a mobility report, and e.g. may include at least one of the following reports described above: a failure report, a successful mobility report, a random access report (RA report), a connection establishment failure report (CEF report), or other reports, etc., and for details, relevant technologies may be referred to.

In some embodiments, the LTM connection failure information includes at least one of the following:
first information for indicating that a mobility type related to a connection failure is LTM;
second information for indicating a time duration corresponding to the connection failure;
third information for indicating a cell where the connection failure occurs; or
fourth information for indicating a type of the connection failure.

In the above embodiments, the connection failure e.g. may include a radio link failure (RLF), a handover failure (HOF), or a failure type of a connection failure between a terminal equipment and a current serving cell caused by timer expiry or other reasons, as described above, and so on, and for details, relevant technologies may be referred to.

In the above embodiments, the time duration is a time duration from when the terminal equipment received a handover command for the last time (the most recent time) or when the terminal equipment received a reconfiguration message for the last time (the most recent time) or when the terminal equipment received an LTM cell switch message for the last time (the most recent time) to when the terminal equipment detected the connection failure. Details will be described in subsequent embodiments.

FIG. 3 is a schematic diagram of an information interaction process according to a method in embodiments of the present disclosure. As shown in FIG. 3, the process includes:
310: a terminal equipment receives LTM candidate cell configuration information (LTM cfg) transmitted by a source base station (SgNB);
320: the terminal equipment determines that a connection failure occurs in an LTM procedure;
330: the terminal equipment records LTM connection failure information into a first report;
340: the terminal equipment transmits the first report to a reception node;
350: the reception node transmits the first report to the source base station (SgNB) and/or a target base station (TgNB); and
360: the source base station or the target base station determines a type of an LTM connection failure according to the first report.

In operation 310, the LTM candidate cell configuration information may include cell information of a candidate cell, the candidate cell being configured by the source base station for the terminal equipment, and for details, relevant technologies may be referred to.

In operation 320, the connection failure may occur between the terminal equipment and a current serving cell, or may occur between the terminal equipment and an LTM target cell. In addition, the connection failure may occur at any time point after operation 310. The current serving cell is a cell under the source base station, and the LTM target cell may be a cell under the source base station or may be a cell under the target base station.

In operation 330, the first report may be an RLF report, however the present disclosure is not limited thereto. As described above, the first report may be any report in a mobility report.

In operation 330, as described above, the LTM connection failure information may include the first information for indicating that a mobility type related to the connection failure is LTM. According to an indication of the first information, the network device may determine that the mobility type related to the connection failure is LTM.

In the above examples, the first information may explicitly indicate that a mobility type related to the connection failure is LTM, or the first information may further be LTM-related information to implicitly indicate that a mobility type related to the connection failure is LTM. For example, the first information may be configuration information of an LTM candidate cell or other LTM-related information.

In operation 330, as described above, the LTM connection failure information may further include the second information for indicating a time duration corresponding to the connection failure. For example, the second information may indicate a time duration from when the terminal equipment received a handover command for the last time or when the terminal equipment received a reconfiguration message for the last time or when the terminal equipment received an LTM cell switch message (such as an LTM cell switch command message) for the last time to when the terminal equipment detected the connection failure. According to the time duration indicated by the second information, the network device may determine the type of the connection failure.

In operation 330, as described above, the LTM connection failure information may further include the third information for indicating cell information of a cell where the connection failure occurs, and according to the cell information of a cell where the connection failure occurs as indicated by the third information, the network device may determine the cell where the connection failure occurs.

In the above examples, the cell information may include at least one of the following: at least one of a cell global identifier (CGI), a physical cell identifier (PCI) and frequency point information, a cell identifier (cell ID), a non-public network identifier (NPN ID), a non-terrestrial network identifier (NTN ID), or other cell identifier. The CGI may include a public land mobile network identifier (PLMN ID) and a cell ID. Optionally, the cell information may further include a tracking area code (TAC) and/or identifier information of a network device to which a cell belongs, such as a global network device identifier.

In the above examples, the third information may be used in combination with the second information. For example, in operation 330, the terminal equipment may include both the second information and the third information in the first report, however the present disclosure is not limited thereto.

In operation 330, as described above, the LTM connection failure information may further include the fourth information for indicating a type of the connection failure. The type of the connection failure may be e.g. a handover failure or a radio link failure. According to the fourth information, the network device may determine the type of the connection failure.

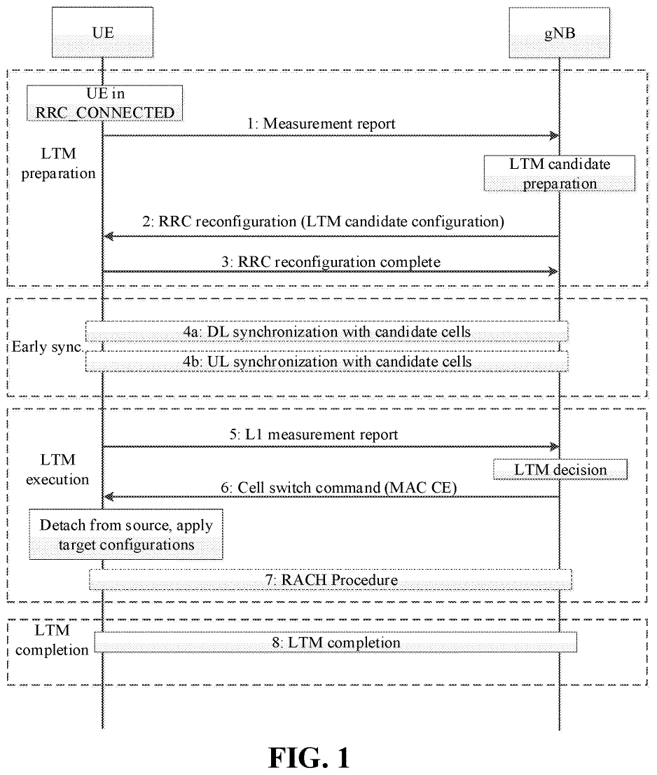

As a possible example, the handover failure may occur in steps 6 to 8 shown in FIG. 1, the radio link failure may occur outside steps 6 to 8 shown in FIG. 1, for example, before step 6, a radio link failure occurs between the terminal equipment and a previous serving cell, and for another example, after step 8, a radio link failure occurs between the terminal equipment and an LTM target cell.

In each of the above examples, the network device may be a reception node or a source base station or a target base station that receives the first report as shown in FIG. 3.

In operation 340, the reception node is an access network device, and transmits a first report request to a terminal equipment after the terminal equipment accesses a cell under the access network device, and the terminal equipment transmits a generated first report to the access network device.

In the example of FIG. 3, that an access network device is different from a source base station and a target base station is taken as an example, however the present disclosure is not limited thereto, the access network device may further be a source base station or a target base station shown in FIG. 3.

In operation 350, after receiving the first report, the access network device may forward the first report to a source base station and/or a target base station (a first network device).

In operation 360, after receiving the first report, the source base station and/or the target base station (a first network device) may determine the type of the LTM connection failure according to the first report.

In some embodiments of operation 360, that the source base station and/or the target base station (a first network device) determines the type of the LTM connection failure according to the first report comprises:

if it is determined according to the first report that the terminal equipment has received configuration information of an LTM candidate cell and has detected a connection failure with a cell that transmits the configuration information of the LTM candidate cell (i.e., a source serving cell of the terminal equipment), and if the second information (i.e., information for indicating a time duration corresponding to a connection failure) is not in the first report, or if the time duration indicated by the second information in the first report is greater than or equal to a first time threshold, it is determined that the type of the LTM connection failure corresponding to the first report is too late LTM.

In the above embodiments, the first time threshold is used to indicate threshold information of a connection duration between the terminal equipment and a network device where the connection failure occurs (called a second network device), and may be predefined by a protocol, or may be configured by an OAM device. The first time threshold may be called e.g. Tstore_UE_cntxt, however the present disclosure is not limited thereto.

In the above embodiments, in the protocol, too late LTM may be defined as follows:
Too late LTM refers to that:
a terminal equipment has received first configuration information (e.g., configuration information of an LTM candidate cell) transmitted by a second network device where a connection failure occurs, the first configuration information including information of at least one LTM candidate cell, and before the terminal equipment successfully receives a first message (e.g., an LTM cell switch command message), transmitted by the second network device, for indicating the terminal equipment to perform LTM cell switch, the terminal equipment detects a connection failure with the second network device, and the terminal equipment does not report the second information, or the second information reported by the terminal equipment is greater than or equal to a first time threshold.

It is understandable that the second network device is a network device to which a source serving cell of the terminal equipment belongs.

In the above embodiments, as described above, the second information is used to indicate a time duration from when the terminal equipment received a handover command (or a reconfiguration message, or an LTM cell switch message) for the last (or the most recent) time to when the terminal equipment detected a connection failure, and may also be called connection failure time information. The LTM cell switch message is e.g. an LTM cell switch command message.

In the above embodiments, relevant contents regarding the LTM connection failure information have been described above, and contents thereof are incorporated here.

In the above embodiments, the too late LTM may also be called too late handover, or too late LTM cell switch, etc.

In the above embodiments, the following modification may be made to the following relevant description in the protocol:

The “UE reported timer” above indicates the time elapsed since the last handover
initialisation until connection failure or the time elapsed since the CHO execution until
connection failure or the time elapsed since the last LTM cell switch command until
connection failure.

In the above embodiments, the following modification may be made to the following relevant description in the protocol:

Intra-system Too Late Handover: there is no recent handover for the UE prior to the
connection failure e.g. the UE reported timer is absent or larger than the configured threshold
(e.g. Tstore_UE_cntxt), or if CHO is configured but the CHO execution is not initiated for
the UE prior to the connection failure, e.g. the UE reported timer is absent or larger than the
configured threshold (e.g. Tstore_UE_cntxt), or if LTM is configured but there is no recent
LTM cell switch command for the UE prior to the connection failure, e.g. the UE
reported timer is absent or larger than the configured threshold (e.g. Tstore_UE_cntxt).

In some other embodiments of operation 360, that the source base station and/or the target base station (a first network device) determines the type of the LTM connection failure according to the first report comprises:
if it is determined according to the first report that the terminal equipment has detected a connection failure with an LTM target cell, and if the time duration indicated by the second information in the first report is less than or equal to a second time threshold, and a cell where the terminal equipment attempts re-establishment for the first time or a cell where the terminal equipment attempts LTM recovery for the first time is a cell where the terminal equipment receives an LTM cell switch message (such as an LTM cell switch command message) or a cell where the terminal equipment receives an LTM initialization message, it is determined that the type of the LTM connection failure corresponding to the first report is too early LTM.

In the above embodiments, the second time threshold is used to indicate threshold information of a connection duration between the terminal equipment and a network device where the connection failure occurs (called a second network device), and may be predefined by a protocol, or may be configured by an OAM device. The second threshold and the first threshold may be the same, the second time threshold may be called e.g. Tstore_UE_cntxt, the second threshold and the first threshold may further be different, however the present disclosure is not limited thereto.

In the above embodiments, in the protocol, too early LTM may be defined as follows:
Too early LTM refers to that:
before the connection failure, a terminal equipment has performed LTM cell switch or LTM initialization, and second information reported by the terminal equipment is less than or equal to a second time threshold, and a cell where the terminal equipment attempts re-establishment for the first time or a cell where the terminal equipment attempts LTM recovery for the first time is a cell where the terminal equipment receives an LTM cell switch message or a cell where the terminal equipment receives an LTM initialization message.

It is understandable that the second network device is a network device to which a source serving cell of the terminal equipment belongs.

In the above embodiments, relevant contents regarding the LTM connection failure information and relevant contents regarding the second information have been described above, and contents thereof are incorporated here.

In the above embodiments, the too early LTM may also be called too early handover, or too early LTM cell switch, etc.

In the above embodiments, the following modification may be made to the following relevant description in the protocol:

Intra-system Too Early Handover: there is a recent handover or LTM cell switch command
for the UE prior to the connection failure e.g. the UE reported timer is smaller than the
configured threshold (e.g. Tstore_UE_cntxt), and the first re-establishment attempt cell/the
successful re-connect cell/the cell UE attempts LTM recovery is the cell that served the UE
at the last handover or LTM initialisation or fall back to the source cell configuration in case
of DAPS HO.

In some further embodiments of operation 360, that the source base station and/or the target base station (a first network device) determines the type of the LTM connection failure according to the first report comprises:
if it is determined according to the first report that the terminal equipment has detected a connection failure with an LTM target cell, and if the time duration indicated by the second information in the first report is less than or equal to a third time threshold, and a cell where the terminal equipment attempts re-establishment for the first time or a cell where the terminal equipment attempts LTM recovery for the first time is a cell other than a cell where the terminal equipment receives an LTM cell switch message (such as an LTM cell switch command message) or a cell where the terminal equipment receives an LTM initialization message, or the LTM target cell, it is determined that the type of the LTM connection failure corresponding to the first report is LTM to wrong cell.

In the above embodiments, the third time threshold is used to indicate threshold information of a connection duration between the terminal equipment and a network device where the connection failure occurs (called a second network device), and may be predefined by a protocol, or may be configured by an OAM device. The third time threshold and the first time threshold may be the same. For example, the third time threshold may be called Tstore_UE_cntxt. The third time threshold may further be different from the first time threshold or the second time threshold. However, the present application is not limited thereto.

In the above embodiments, in the protocol, LTM to wrong cell may be defined as follows:
LTM to wrong cell refers to that:
before the connection failure, a terminal equipment has performed LTM cell switch (such as LTM cell switch) or LTM initialization, and second information reported by the terminal equipment is less than or equal to a third time threshold, and a cell where the terminal equipment attempts re-establishment for the first time or a cell where the terminal equipment attempts LTM recovery for the first time is neither a cell where the terminal equipment receives an LTM cell switch message (an LTM cell switch command message) or a cell (i.e., a source cell) where the terminal equipment receives an LTM initialization message, nor a cell where the terminal equipment detects a failure or the LTM target cell.

It is understandable that the second network device is a network device to which a source serving cell of the terminal equipment belongs.

In the above embodiments, relevant contents regarding the LTM connection failure information and relevant contents regarding the second information have been described above, and contents thereof are incorporated here.

In the above embodiments, the LTM to wrong cell may also be called handover to wrong cell, or LTM cell switch to wrong cell, etc.

In the above embodiments, the following modification may be made to the following relevant description in the protocol:

Intra-system Handover to Wrong Cell: there is a recent handover or LTM for the UE prior
to the connection failure e.g. the UE reported timer is smaller than the configured threshold
(e.g. Tstore_UE_cntxt), and the first re-establishment attempt cell/the cell UE attempts to re-
connect/the cell UE attempts CHO recovery/the cell UE attempts LTM recovery is neither
the cell that served the UE at the last handover initialisation or LTM initialisation nor the
cell that served the UE where the RLF happened or the cell that the handover or LTM was
initialized toward.

Each of the above embodiments only exemplarily describes a method in embodiments of the present disclosure, however the present disclosure is not limited thereto, and appropriate variation(s) may be further made based on each of the above embodiments. For example, each of the above embodiments may be used individually, or one or more of the above embodiments may be combined.

According to methods in embodiments of the present disclosure, a SON enhancement scheme in an LTM scenario is introduced, failure information related to LTM reported by a UE is introduced, and an LTM failure scenario is defined, such that a network device may identify an LTM failure scenario according to a mobility report related to an LTM scenario, thereby to perform corresponding parameter adjustments, and thus LTM robustness is improved.

### Embodiments of a Second Aspect

Embodiments of the present disclosure provide a method for mobility management, which is described from a terminal equipment side. Contents same as those in embodiments of the first aspect are not repeated again.

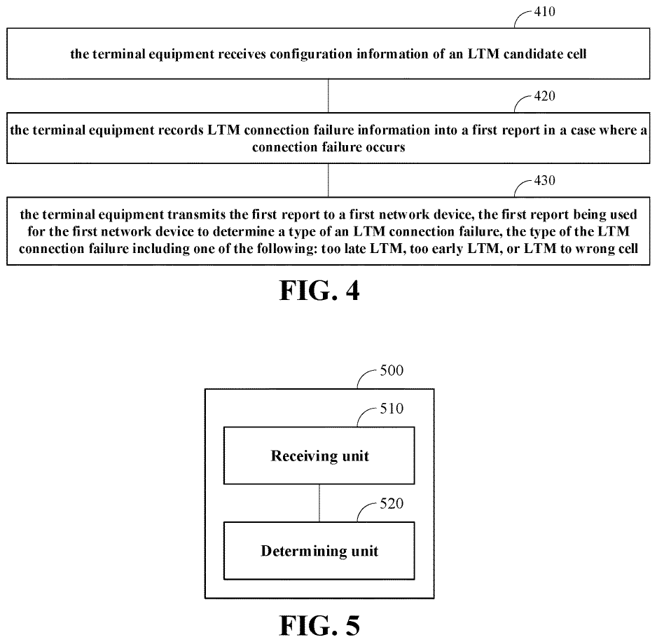

FIG. 4 is a schematic diagram of the method for mobility management in embodiments of the present disclosure, as shown in FIG. 4, the method includes:
410: the terminal equipment receives configuration information of an LTM candidate cell;
420: the terminal equipment records LTM connection failure information into a first report in a case where a connection failure occurs; and
430: the terminal equipment transmits the first report to a first network device, the first report being used for the first network device to determine a type of an LTM connection failure, the type of the LTM connection failure including one of the following: too late LTM, too early LTM, or LTM to wrong cell.

It is worth noting that the above FIG. 4 only schematically describes embodiments of the present disclosure, however the present disclosure is not limited thereto. For example, an execution step of operations may be adjusted appropriately, and other some operations may further be increased or certain operations therein may be reduced. Persons skilled in the art may make appropriate modifications according to the above contents, not being limited to records in the above FIG. 4.

In embodiments of the present disclosure, the LTM connection failure information includes at least one of the following:
first information for indicating that a mobility type related to a connection failure is LTM;
second information for indicating a time duration corresponding to the connection failure;
third information for indicating a cell where the connection failure occurs; or
fourth information for indicating a type of the connection failure.

Relevant contents regarding the first to fourth information have been described in embodiments of the first aspect, are incorporated here, and are not repeated here.

According to methods in embodiments of the present disclosure, a SON enhancement scheme in an LTM scenario is introduced, failure information related to LTM reported by a UE is introduced, and an LTM failure scenario is defined, such that a network device may identify an LTM failure scenario according to a mobility report related to an LTM scenario, thereby to perform corresponding parameter adjustments, and thus LTM robustness is improved.

### Embodiments of a Third Aspect

Embodiments of the present disclosure provide an apparatus for mobility management.

FIG. 5 is a schematic diagram of the apparatus for mobility management in embodiments of the present disclosure. The apparatus may be e.g. a network device, or may be one or more parts or components configured in a network device. Principles of the apparatus to solve problems are same as the method in embodiments of the first aspect, thus specific implementation thereof may refer to implementation of the method in embodiments of the first aspect, and the same contents are not repeated.

As shown in FIG. 5, the apparatus 500 includes:
a receiving unit 510 configured to receive a first report transmitted by a terminal equipment, the first report including LTM connection failure information; and
a determining unit 520 configured to determine a type of an LTM connection failure according to the first report, the type of the LTM connection failure including one of the following: too late LTM, too early LTM, or LTM to wrong cell.

In some embodiments, the LTM connection failure information includes at least one of the following:
first information for indicating that a mobility type related to a connection failure is LTM;
second information for indicating a time duration corresponding to the connection failure;
third information for indicating a cell where the connection failure occurs; or
fourth information for indicating a type of the connection failure.

In the above embodiments, the time duration may be a time duration from when the terminal equipment received a handover command for the last time or when the terminal equipment received a reconfiguration message for the last time or when the terminal equipment received an LTM cell switch message for the last time to when the terminal equipment detected a connection failure.

In some embodiments, that the determining unit 520 determines the type of the LTM connection failure according to the first report comprises:
if it is determined according to the first report that the terminal equipment has received configuration information of an LTM candidate cell and has detected a connection failure with a cell that transmits the configuration information of the LTM candidate cell, and if the second information is not in the first report, or if the time duration indicated by the second information in the first report is greater than or equal to a first time threshold, the determining unit 520 determines that the type of the LTM connection failure corresponding to the first report is too late LTM.

In the above embodiments, the first time threshold is used to indicate threshold information of a connection duration between the terminal equipment and a second network device where a connection failure occurs, the first time threshold is predefined, or is configured by an operation administration and maintenance device.

In the above embodiments, the too late LTM refers to that:
the terminal equipment receives first configuration information transmitted by a second network device where a connection failure occurs, the first configuration information includes information of at least one LTM candidate cell, and before the terminal equipment successfully receives a first message transmitted by the second network device, the terminal equipment has detected a connection failure with the second network device, and the terminal equipment does not report the second information or the second information reported by the terminal equipment is greater than or equal to the first time threshold, the first message is used to indicate the terminal equipment to perform LTM cell switch.

In some other embodiments, that the determining unit 520 determines the type of the LTM connection failure according to the first report comprises:
if it is determined according to the first report that the terminal equipment has detected a connection failure with an LTM target cell, and if the time duration indicated by the second information in the first report is less than or equal to a second time threshold, and a cell where the terminal equipment attempts re-establishment for the first time or a cell where the terminal equipment attempts LTM recovery for the first time is a cell where the terminal equipment receives an LTM cell switch message or a cell where the terminal equipment receives an LTM initialization message, the determining unit 520 determines that the type of the LTM connection failure corresponding to the first report is too early LTM.

In the above embodiments, the second time threshold is used to indicate threshold information of a connection duration between the terminal equipment and a second network device where the connection failure occurs, the second time threshold is predefined, or is configured by an operation administration and maintenance device.

In the above embodiments, the too early LTM refers to that:
before the connection failure, the terminal equipment has performed LTM cell switch or LTM initialization, and the second information reported by the terminal equipment is less than or equal to the second time threshold, and a cell where the terminal equipment attempts re-establishment for the first time or a cell where the terminal equipment attempts LTM recovery for the first time is a cell where the terminal equipment receives the LTM cell switch message or a cell where the terminal equipment receives the LTM initialization message.

In some further embodiments, that the determining unit 520 determines the type of the LTM connection failure according to the first report comprises:
if it is determined according to the first report that the terminal equipment has detected a connection failure with an LTM target cell, and if the time duration indicated by the second information in the first report is less than or equal to a third time threshold, and a cell where the terminal equipment attempts re-establishment for the first time or a cell where the terminal equipment attempts LTM recovery for the first time is a cell other than a cell where the terminal equipment receives an LTM cell switch message or a cell where the terminal equipment receives an LTM initialization message, or the LTM target cell, the determining unit 520 determines that the type of the LTM connection failure corresponding to the first report is LTM to wrong cell.

In the above embodiments, the third time threshold is used to indicate threshold information of a connection duration between the terminal equipment and a second network device where the connection failure occurs, the third time threshold is predefined, or is configured by an operation administration and maintenance device.

In the above embodiments, the LTM to wrong cell refers to that:
before the connection failure, the terminal equipment has performed LTM cell switch or LTM initialization, and the second information reported by the terminal equipment is less than or equal to the third time threshold, and a cell where the terminal equipment attempts re-establishment for the first time or a cell where the terminal equipment attempts LTM recovery for the first time is neither a cell where the terminal equipment receives the LTM cell switch message or a cell where the terminal equipment receives the LTM initialization message, nor a cell where the terminal equipment detects a failure or the LTM target cell.

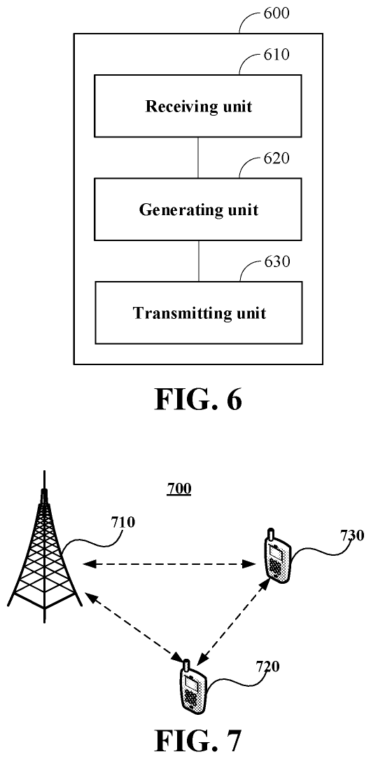

FIG. 6 is another schematic diagram of the apparatus for mobility management in embodiments of the present disclosure. The apparatus may be a terminal equipment, or may be one or more parts or components configured in a terminal equipment. Principle of the apparatus to solve problems are same as the method in embodiments of the second aspect, thus for its specific implementation, implementation of the method in embodiments of the second aspect may be referred to, and the same contents are not repeated.

As shown in FIG. 6, the apparatus 600 includes:
a receiving unit 610 configured to receive configuration information of an LTM candidate cell;
a generating unit 620 configured to record LTM connection failure information into a first report in a case where a connection failure occurs; and
a transmitting unit 630 configured to transmit the first report to a first network device, the first report being used for the first network device to determine a type of an LTM connection failure, the type of the LTM connection failure including one of the following: too late LTM, too early LTM, or LTM to wrong cell.

In some embodiments, the LTM connection failure information includes at least one of the following:
first information for indicating that a mobility type related to a connection failure is LTM;
second information for indicating a time duration corresponding to the connection failure;
third information for indicating a cell where the connection failure occurs; or
fourth information for indicating a type of the connection failure.

In the above embodiments, the time duration may be a time duration from when the terminal equipment received a handover command for the last time or when the terminal equipment received a reconfiguration message for the last time or when the terminal equipment received an LTM cell switch message for the last time to when the terminal equipment detected a connection failure.

The above text provides an exemplary description of embodiments of the present disclosure, but the present disclosure is not limited thereto, appropriate variation(s) may be further made based on each of the above embodiments. For example, each of the above embodiments may be used individually, or one or more of the above embodiments may be combined.

It is worth noting that the above text only describes components or modules related to the present disclosure, however the present disclosure is not limited thereto. The above apparatuses may further include other components or modules. For detailed contents of these components or modules, relevant technologies may be referred to. Moreover, each of the above components or modules may be implemented via a hardware facility such as a processor, a memory, a transmitter, a receiver, etc. Embodiments of the present disclosure have no limitation thereto.

According to apparatuses in embodiments of the present disclosure, a SON enhancement scheme in an LTM scenario is introduced, failure information related to LTM reported by a UE is introduced, and an LTM failure scenario is defined, such that a network device may identify an LTM failure scenario according to a mobility report related to an LTM scenario, thereby to perform corresponding parameter adjustments, and thus LTM robustness is improved.

### Embodiments of a Fourth Aspect

Embodiments of the present disclosure further provide a communication system, including a network device and a terminal equipment.

FIG. 7 is a schematic diagram of the communication system in embodiments of the present disclosure, schematically describing a situation by taking the terminal equipment and the network device as an example, and as shown in FIG. 7, a communication system 700 may include a network device 710 and terminal equipments 720, 730. For simplicity, FIG. 7 only takes two terminal equipments and one network device as an example for description, however embodiments of the present disclosure are not limited thereto.

In embodiments of the present disclosure, transmission of existing services or future implementable services may be performed between the network device 710 and terminal equipments 720, 730. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 7 shows that two terminal equipments 720 and 730 are within a coverage range of the network device 710, however the present disclosure is not limited thereto. Two terminal equipments 720 and 730 may be not within the coverage range of the network device 710, or one terminal equipment 720 is within the coverage range of the network device 710 while the other terminal equipment 730 is outside the coverage range of the network device 710.

In some embodiments, the network device includes the apparatus 500 in embodiments of the third aspect, configured to perform the method in embodiments of the first aspect. Since the method has been described in details in embodiments of the first aspect, contents thereof are incorporated here and are not repeated.

The network device may be a gNB under an intra-DU mobility scenario, including a gNB-DU and a gNB-CU, or may be a gNB under an inter-DU mobility scenario, including a source gNB-DU, a candidate or target gNB-DU and a gNB-CU, to perform the method in the embodiments of the first aspect.

In some embodiments, the terminal equipment includes the apparatus 600 in embodiments of the third aspect, configured to perform the method in embodiments of the second aspect. Since the method has been described in details in embodiments of the second aspect, contents thereof are incorporated here and are not repeated.

The terminal equipment may be a UE under an intra-DU mobility scenario or an inter-DU mobility scenario, and performs the method in embodiment of the second aspect.

Embodiments of the present disclosure further provide a network device, the network device may be e.g. a base station, such as a gNB under an intra-DU mobility scenario or an inter-DU mobility scenario, however the present disclosure is not limited thereto, the network device may further be other network device.

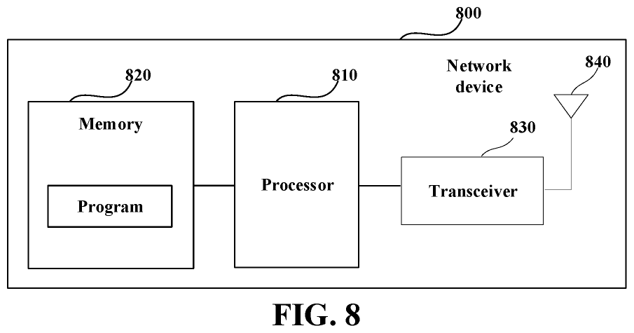

FIG. 8 is a composition schematic diagram of the network device in embodiments of the present disclosure. As shown in FIG. 8, a network device 800 may include: a processor 810, and a memory 820 coupled to the processor 810. The memory 820 may store various data; moreover, further stores a program for information processing, and executes the program under control of the processor 810.

In some embodiments, functions of the apparatus 500 in embodiments of the third aspect may be integrated into the processor 810, wherein the processor 810 may be configured to execute a program to implement the method described in embodiments of the first aspect, contents thereof are incorporated here and are not repeated here.

In some other embodiments, the apparatus 500 in embodiments of the third aspect may be configured separately from the processor 810, for example the apparatus 500 in embodiments of the third aspect may be configured as a chip connected to the processor 810, and functions of the apparatus 500 in embodiments of the third aspect are implemented via control of the processor 810.

In addition, as shown in FIG. 8, the network device 800 may further include: transceivers 830 and 840. Functions of the above components are similar to related arts, and are not further elaborated here. It is worth noting that the network device 800 does not have to include all components shown in FIG. 8. Moreover, the network device 800 may further include components not shown in FIG. 8, related arts may be referred to.

Embodiments of the present disclosure further provide a terminal equipment, the terminal equipment may be e.g. a UE, such as a UE under an intra-DU mobility scenario or an inter-DU mobility scenario, however the present disclosure is not limited thereto, the terminal equipment may further be other terminal equipment.

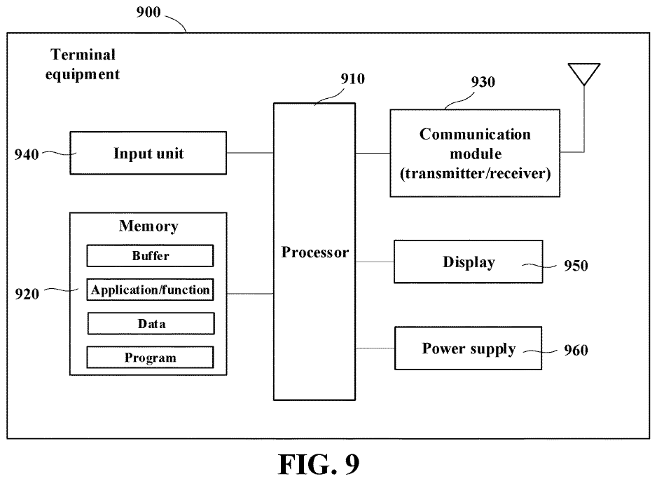

FIG. 9 is a schematic diagram of the terminal equipment in embodiments of the present disclosure. As shown in FIG. 9, the terminal equipment 900 may include a processor 910 and a memory 920; the memory 920 stores data and programs, and is coupled to the processor 910. It is worth noting that this figure is exemplary, other types of structures may also be used to supplement or replace this structure, so as to implement a telecommunication function or other functions.

In some embodiments, functions of the apparatus 600 in embodiments of the third aspect may be integrated into the processor 910, wherein the processor 910 may be configured to execute a program to implement the method described in embodiments of the second aspect, contents thereof are incorporated here and are not repeated here.

In some other embodiments, the apparatus 600 in embodiments of the third aspect may be configured separately from the processor 910, for example the apparatus 600 in embodiments of the third aspect may be configured as a chip connected to the processor 910, and functions of the apparatus 600 in embodiments of the third aspect are implemented via control of the processor 910.

As shown in FIG. 9, the terminal equipment 900 may further include: a communication module 930, an input unit 940, a display 950, and a power supply 960. Functions of the above components are similar to related arts, and are not further elaborated here. It is worth noting that the terminal equipment 900 does not have to include all components shown in FIG. 9, the above components are not indispensable. Moreover, the terminal equipment 900 may further include components not shown in FIG. 9, and relevant technologies may be referred to.

Embodiments of the present disclosure further provide a computer program, wherein when the program is executed in a network device, the program enables the network device to execute the method described in embodiments of the first aspect.

Embodiments of the present disclosure further provide a storage medium in which a computer program is stored, wherein the computer program enables a network device to execute the method described in embodiments of the first aspect.

Embodiments of the present disclosure further provide a computer program, wherein when the program is executed in a terminal equipment, the program enables the terminal equipment to execute the method described in embodiments of the second aspect.

Embodiments of the present disclosure further provide a storage medium in which a computer program is stored, wherein the computer program enables a terminal equipment to execute the method described in embodiments of the second aspect.

Apparatuses and methods in the present disclosure may be implemented by hardware, or may be implemented by combining hardware with software. The present disclosure relates to such a computer readable program that when the program is executed by a logic component, the logic component is able to implement apparatuses described in the above text or a constituent component, or the logic component is able to implement various methods or steps described in the above text. The present disclosure further relates to a storage medium storing the above programs, such as a hard disk, a magnetic disk, an optical disk, a DVD, a flash memory and the like.

Methods/apparatuses described by combining with embodiments of the present disclosure may be directly embodied as hardware, a software module executed by a processor, or a combination of the two. For example, one or more of functional block diagrams shown in drawings or one or more combinations of functional block diagrams may correspond to software modules of a computer program process, or may correspond to hardware modules. These software modules may respectively correspond to steps shown in drawings. These hardware modules may be implemented by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM, or any other form of storage medium known in the art. A storage medium may be coupled to a processor, thus enabling the processor to read information from the storage medium and write information into the storage medium, or the storage medium may be a constituent part of a processor. A processor and a storage medium may be located in an ASIC. The software module may be stored in a memory of a mobile terminal, or may be stored in a memory card that may be inserted into a mobile terminal. For example, if a device (e.g., a mobile terminal) adopts a MEGA-SIM card with a larger capacity or a flash memory apparatus with a large capacity, the software module may be stored in the MEGA-SIM card, or in the flash memory apparatus with a large capacity.

One or more of functional block diagrams described in drawings or one or more combinations of functional block diagrams may be implemented as a general-purpose processor for performing functions described in the present disclosure, a digital signal processor (DSP), an application-specific integrated circuit (ASIC), a field-programmable gate array (FPGA) or other programmable logic device, a discrete gate or a transistor logic device, a discrete hardware component, or any appropriate combination thereof. One or more of functional block diagrams described in drawings or one or more combinations of functional block diagrams may further be implemented as a combination of computing devices, such as a combination of a DSP and a microprocessor, a plurality of microprocessors, one or more microprocessors combined and communicating with a DSP, or any other such configuration.

The present disclosure is described above by combining with specific implementations, however persons skilled in the art should clearly know that these descriptions are exemplary and do not limit protection scopes of the present disclosure. Persons skilled in the art may make various variations and amendments to the present disclosure according to spirits and principles of the present disclosure, these variations and amendments are also within scopes of the present disclosure.

What is claimed is:

1. An apparatus for mobility management, configured in a first network device, the apparatus comprising:
a receiver configured to receive a first report transmitted by a terminal equipment, the first report comprising LTM (layer 1/layer 2 triggered mobility) connection failure information; and
processor circuitry configured to determine a type of an LTM connection failure according to the first report, the type of the LTM connection failure comprising one of the following: too late LTM, too early LTM, or LTM to wrong cell.

2. The apparatus according to claim 1, wherein the LTM connection failure information comprises at least one of the following:
first information for indicating that a mobility type related to a connection failure is LTM;
second information for indicating a time duration corresponding to a connection failure;
third information for indicating a cell where a connection failure occurs; or
fourth information for indicating a type of a connection failure.

3. The apparatus according to claim 2, wherein,
the time duration is a time duration from when the terminal equipment received a handover command for the last time or when the terminal equipment received a reconfiguration message for the last time or when the terminal equipment received an LTM cell switch message for the last time to when the terminal equipment detected the connection failure.

4. The apparatus according to claim 2, wherein that the processor circuitry determines a type of an LTM connection failure according to the first report comprises that:
if it is determined according to the first report that the terminal equipment has received configuration information of an LTM candidate cell, and the terminal equipment has detected a connection failure with a cell that transmits the configuration information of the LTM candidate cell, and,
if the second information is not in the first report, or if a time duration indicated by the second information in the first report is greater than or equal to a first time threshold,
the processor circuitry determines that the type of the LTM connection failure corresponding to the first report is too late LTM.

5. The apparatus according to claim 4, wherein,
the first time threshold is used to indicate threshold information on a connection duration between the terminal equipment and a second network device where the connection failure occurs; and
the first time threshold is predefined, or configured by an operation administration and maintenance device.

6. The apparatus according to claim 4, wherein the too late LTM refers to that:
the terminal equipment receives first configuration information transmitted by a second network device where the connection failure occurs, the first configuration information comprises information of at least one LTM candidate cell, and before the terminal equipment successfully receives a first message for indicating the terminal equipment to perform LTM cell switch transmitted by the second network device, the terminal equipment has detected a connection failure with the second network device, and the terminal equipment does not report the second information or the second information reported by the terminal equipment is greater than or equal to the first time threshold.

7. The apparatus according to claim 2, wherein that the processor circuitry determines a type of an LTM connection failure according to the first report comprises that:
if it is determined according to the first report that the terminal equipment has detected a connection failure with an LTM target cell, and,
if a time duration indicated by the second information in the first report is less than or equal to a second time threshold, and a cell where the terminal equipment attempts re-establishment for the first time or a cell where the terminal equipment attempts LTM recovery for the first time is a cell where the terminal equipment receives an LTM cell switch message or a cell where the terminal equipment receives an LTM initialization message,
the processor circuitry determines that the type of the LTM connection failure corresponding to the first report is too early LTM.

8. The apparatus according to claim 7, wherein,
the second time threshold is used to indicate threshold information on a connection duration between the terminal equipment and a second network device where the connection failure occurs; and
the second time threshold is predefined, or configured by an operation administration and maintenance device.

9. The apparatus according to claim 7, wherein the too early LTM refers to that:
before the connection failure, the terminal equipment has performed LTM cell switch or LTM initialization, and the second information reported by the terminal equipment is less than or equal to the second time threshold, and a cell where the terminal equipment attempts re-establishment for the first time or a cell where the terminal equipment attempts LTM recovery for the first time is a cell where the terminal equipment receives the LTM cell switch message or a cell where the terminal equipment receives the LTM initialization message.

10. The apparatus according to claim 2, wherein that the processor circuitry determines a type of an LTM connection failure according to the first report comprises that:
if it is determined according to the first report that the terminal equipment has detected a connection failure with an LTM target cell, and,
if a time duration indicated by the second information in the first report is less than or equal to a third time threshold, and a cell where the terminal equipment attempts re-establishment for the first time or a cell where the terminal equipment attempts LTM recovery for the first time is a cell other than a cell where the terminal equipment receives an LTM cell switch message or a cell where the terminal equipment receives an LTM initialization message, or the LTM target cell,
the processor circuitry determines that the type of the LTM connection failure corresponding to the first report is LTM to wrong cell.

11. The apparatus according to claim 10, wherein,
the third time threshold is used to indicate threshold information on a connection duration between the terminal equipment and a second network device where the connection failure occurs; and
the third time threshold is predefined, or configured by an operation administration and maintenance device.

12. The apparatus according to claim 10, wherein the LTM to wrong cell refers to that:
before the connection failure, the terminal equipment has performed LTM cell switch or LTM initialization, and the second information reported by the terminal equipment is less than or equal to the third time threshold, and a cell where the terminal equipment attempts re-establishment for the first time or a cell where the terminal equipment attempts LTM recovery for the first time is neither a cell where the terminal equipment receives the LTM cell switch message or a cell where the terminal equipment receives the LTM initialization message, nor a cell where the terminal equipment detects a failure or the LTM target cell.

13. An apparatus for mobility management, configured in a terminal equipment, the apparatus comprising:
a receiver configured to receive configuration information of an LTM candidate cell;
processor circuitry configured to record LTM connection failure information into a first report in a case where a connection failure occurs; and
a transmitter configured to transmit the first report to a first network device, the first report being used for the first network device to determine a type of an LTM connection failure, the type of the LTM connection failure comprising one of the following: too late LTM, too early LTM, or LTM to wrong cell.

14. The apparatus according to claim 13, wherein the LTM connection failure information comprises at least one of the following:
first information for indicating that a mobility type related to a connection failure is LTM;
second information for indicating a time duration corresponding to a connection failure;
third information for indicating a cell where a connection failure occurs; or
fourth information for indicating a type of a connection failure.

15. The apparatus according to claim 14, wherein,
the time duration is a time duration from when the terminal equipment received a handover command for the last time or when the terminal equipment received a reconfiguration message for the last time or when the terminal equipment received an LTM cell switch message for the last time to when the terminal equipment detected the connection failure.

16. A network device, comprising:
a memory configured to store a computer readable instruction; and
processor circuitry configured to execute the computer readable instruction to implement:
receiving a first report transmitted by a terminal equipment, the first report comprising LTM (layer 1/layer 2 triggered mobility) connection failure information; and
determining a type of an LTM connection failure according to the first report, the type of the LTM connection failure comprising one of the following: too late LTM, too early LTM, or LTM to wrong cell.
